(19) United States
(12) Patent Application Publication
(10) Pub. No.: US 2013/0327655 A1
(43) Pub. Date: Dec. 12, 2013

(54) ELECTRO-COAGULATION SYSTEM AND METHOD THEREFOR

(71) Applicants: Jeff Briggs, Denton, TX (US); Jim Briggs, Denton, TX (US)

(72) Inventors: Jeff Briggs, Denton, TX (US); Jim Briggs, Denton, TX (US)

(21) Appl. No.: 13/489,945

(22) Filed: Jun. 6, 2012

(51) Int. Cl. C02F 1/463

(52) U.S. Cl. 205/742; 204/275.1; 204/269

(57) ABSTRACT

A method for water treatment system comprising: mixing feed water to be treated with an agent to increase a pH level of the feed water; running the feed water through a plurality of Electro-Coagulation (EC) units; and running the feed water through a plurality of settling tank chambers wherein each successive settling tank chamber removes smaller particles.

### BACKGROUND

Embodiments of this disclosure generally relate to a water treatment system, and more particularly, to a waste water treatment system that uses electro-coagulation.

The impact of polluted water is an environmental problem for industries around the world. Presently there is a growing need for scaled, decentralized water treatment plants. Many industrial and other processes create contaminated water that must be dealt with. Often this means costly transport and disposal of the contaminated water. Even if the water is to be treated at a treatment facility to remove the contaminations, the water may have to first be transported to the facility for treatment.

One of the most efficient methods for removing Total Suspended Solids (TSS), many heavy metals and organic compounds is Electro-Coagulation or EC. Water from municipal waste to oil and gas waste water known as produced water can be cleaned to irrigation quality water or left for further treatment in other equipment by the EC unit, depending on the quality of the feed water. The EC unit is not restricted by the ability to process high Total Dissolved Solids (TDS) water as many other units are. The unit will not remove salinity or other chlorides with di-valent ions. Other treatment equipment may be required in high TDS water, depending on the quality of water the client specifies.

Therefore, it would be desirable to provide a system and method to overcome the above. The system and method would be a scaled, decentralized water treatment plant utilizing EC.

### SUMMARY

A method for water treatment system comprising: mixing feed water to be treated with an agent to increase a pH level of the feed water; running the feed water through a plurality of Electro-Coagulation (EC) units; and running the feed water through a plurality of settling tank chambers wherein each successive settling tank chamber removes smaller particles.

A water treatment system has an Electro-Coagulation (EC) unit. A plurality of settling tank chambers is coupled to the EC unit.

A water treatment system has a mixing unit for receiving feed water to be treated and for combining an agent with the feed water to increase a pH level of the feed water. A plurality of Electro-Coagulation (EC) units is coupled to the mixing unit. A plurality of settling tank chambers is coupled to the EC units, wherein each successive settling tank chamber removes smaller particles. A collection tank is coupled to a last of the plurality of settling tank chambers.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified block diagram of one embodiment of the present invention; and

FIG. 2 is a magnified view of one section of the present invention; and

### DETAILED DESCRIPTION

Electro-Coagulation (EC) is a technique that may be used for wash water treatment, wastewater treatment, industrial processed water, medical treatment and the like. Electricity-based electro-coagulation technology removes contaminants that may be impossible to be removed by filtration or chemical treatment systems, such as emulsified oil, TPH, suspended solids, and heavy metals. Fully automated, EC systems have no filters to clean or replace and does not require use of chemicals.

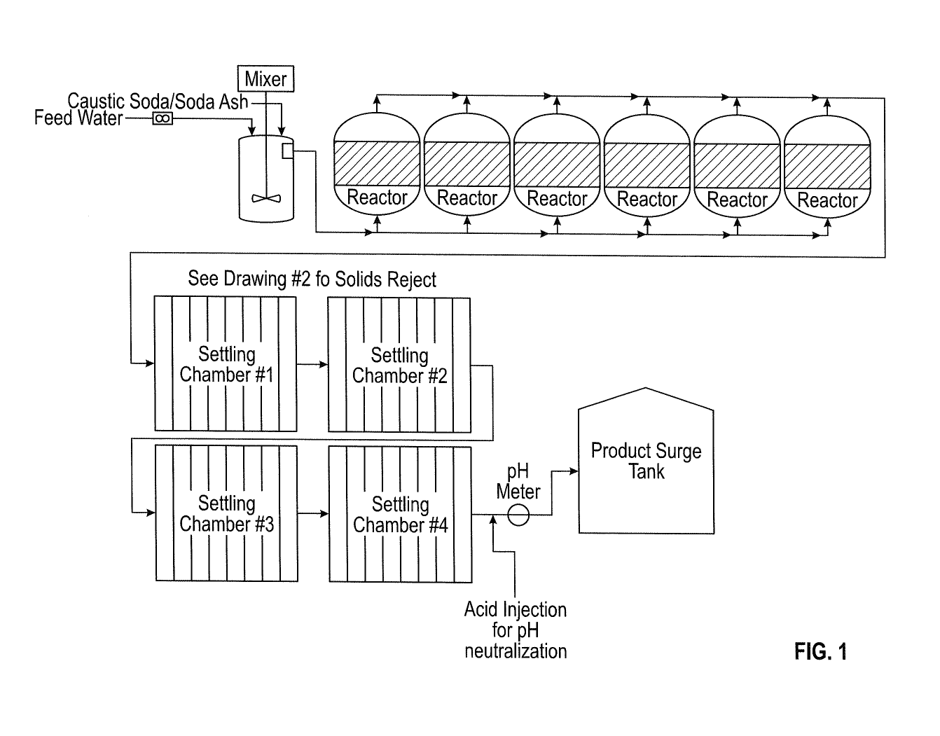

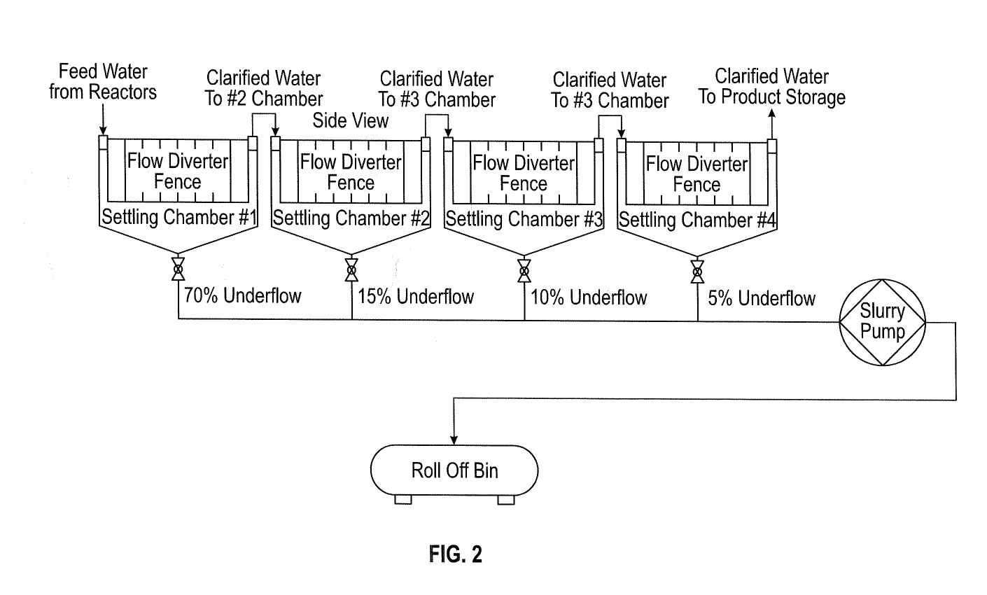

Referring now FIGS. 1-2, an Electro-Coagulation (EC) system 10 and operation will be disclosed. The EC system 10 may allow water from municipal waste, oil and gas waste water known as produced water, and the like to be cleaned to irrigation quality water or left for further treatment in other equipment by the EC system 10, depending on the quality of the feed water. The EC system 10 is not restricted by the ability to process high Total Dissolved Solids (TDS) water as prior art systems are. Other treatment equipment may be required in high TDS water, depending on the quality of water the client specifies.

The EC system 10 works by coagulating mono-valent molecules by exerting a low voltage direct current into the water via metallic plates that contact the water in anionic and cationic oscillation as it flows over the plates. The negative valent ions are attracted to the positive charged ions from the EC plates. This causes the molecules to grow into larger molecules as they grow larger and get heavier they fall out of solution.

As shown in FIG. 1, the EC system 10 has a mixing unit 12. Feed water (i.e., water to be treated) flows into the mixing unit 12 via piping 14. A flow meter 16 may be used to monitor the flow of the feed water flowing into the mixing unit 12. The mixing unit 12 may be used to store the feed water. The mixing unit 12 may further be used to mix soda ash with the feed water. Soda ash may be added to the feed water to increase the pH of the feed water. As shown in the embodiment of FIG. 1, the mixing unit 12 may have an agitating device 18. The agitating device 18 may be used to mix/stir in the soda ash with the feed water. Soda ash may be added as EC may be more effective with high pH waters.

The mixing unit 12 may have an overflow pipe 20. Once the mixed feed water in the mixing unit 12 reaches the overflow pipe 20, the mixed feed water may flow into one of a plurality of EC reactor units 22. Each of the EC reactor units 22 may contain electrically charged plates 24. The charged plates 24 may be positioned to direct the mixed feed water flow evenly across the charged plates 24. The charged plates 24 may be negatively charged (anionic) and positively charged (cationic) to effect the change in molecular structure of molecules.

As stated above, the EC reactor units 22 work by coagulating mono-valent molecules by exerting a low voltage direct current into the water via the electrically charged plates 24 that contact the water in anionic and cationic oscillation as it flows over the electrically charged plates 24. The negative valent ions are attracted to the positive charged ions from the electrically charged plates 24. This causes the molecules to grow into larger molecules as they grow larger and get heavier they fall out of solution.

The mixed feed water which flows into one of a plurality of EC reactor units 22 may fill the EC reactor units 22 causing the mixed feed water to flow out of each of the full EC reactor units 22 via an outlet 22A. The overflow water from the EC reactor units 22 feed into the distributor flume 26 which spreads the water flow evenly across the first of a plurality of settling tank chambers 28.

The settling tank chambers 28 shown in FIGS. 1 and 2 are very unique to water treatment processes. The configuration of the settling tank chambers 28 provide longer retention time that is needed for complete reaction and clarification. The water flows through the first settling tank chamber 28A to remove the large particles that coagulate and fall out easily. Usually, the first chamber collects the majority of the impurities and has the largest pump out nozzle 30 for removal of solids. The outlet 32 of the first settling tank chamber 28A overflows to the second settling tank chamber 28B where the flume 26 spreads the water out again and allows it to pass through the second settling unit. The more difficult particles will begin to separate and fall out. The second settling tank chamber 28B collects the about half the impurities that the first chamber catches and has its own pump out nozzle 34 for removal of solids.

This process continues through the third and fourth settling tank chambers 28C and 28D respectively. The third and fourth settling tank chambers 28C and 28D respectively each have their own pump out nozzle 36 and 38 respectively for removal of solids. The fourth setting tank chamber 28D catches a small amount of solids signifying that the reaction is complete and the water is as clean as can be using this technology. Effluent from the final settling tank chamber 28D flows into a small surge tank 40 where the pH is neutralized for discharge into the final treatment equipment or to other water users. A pH metering device 42 may be used to measure the pH level of the effluent. A device 44 may be used to add pH neutralizer into the effluent.

When the solids settle to the bottom of the settling chambers, they may be removed via a sump pump 46. The sump pump 46 may be used to send the collected particles to a roll-off bin for disposal at a local landfill. The solids level may be drawn down intermittently as the solids levels build.

Many other EC units utilize a small clarifier/settling tank that leaves many impurities still in solution and causes downstream treatment to result in major maintenance costs and sometimes failure of the downstream equipment. The four chambered settling tank configuration has shortened settling time from 12 to 24 hours with conventional clarifiers for comparable water clarity to continuous flow capability.

While embodiments of the disclosure have been described in terms of various specific embodiments, those skilled in the art will recognize that the embodiments of the disclosure may be practiced with modifications within the spirit and scope of the claims.

What is claimed is:

1. A method for water treatment system comprising:
mixing feed water to be treated with an agent to increase a pH level of the feed water;
running the feed water through a plurality of Electro-Coagulation (EC) units; and
running the feed water through a plurality of settling tank chambers wherein each successive settling tank chamber removes smaller particles.

2. The method of claim 1, further comprising removing particles collected in each of the settling tank chambers.

3. The method of claim 1, further comprising arranging charged plates in each EC unit to direct the feed water evenly across the charged plates.

4. The method of claim 1, further comprising adding a pH neutralizer into the feed water after the feed water runs through the settling tanks.

5. The method of claim 1, further comprising running the feed water through at least 4 settling tank chambers wherein each successive settling tank chamber removes smaller particles.

6. A water treatment system comprising:
an Electro-Coagulation (EC) unit; and
a plurality of settling tank chambers coupled to the EC unit.

7. The water treatment system of claim 6, further comprising a mixing unit coupled to the EC unit for combining an agent with feed water to be treated by the system.

8. The water treatment system of claim 6, further comprising a plurality of EC units.

9. The water treatment system of claim 6, further comprising a surge tank coupled to a last of the plurality of settling tank chambers.

10. The water treatment system of claim 7, wherein the agent is soda ash to increase a pH level of the feed water.

11. The water treatment system of claim 6, wherein each successive settling tank chamber removes smaller particles.

12. The water treatment system of claim 6, wherein each settling tank chamber has a pump out nozzle for removing solid particles collect by each settling tank chamber.

13. The water treatment system of claim 6, further comprising a surge pump coupled to each of the plurality of settling tank chambers to remove particles collected in each of the settling tank chambers.

14. The water treatment system of claim 13, further comprising a surge pump coupled to each pump out nozzle to remove particles collected in each of the settling tank chambers.

15. The water treatment system of claim 14, further comprising a surge tank coupled to the surge pump to store the particles.

16. The water treatment system of claim 15, further comprising a surge tank coupled to the surge pump to store the particles.

17. The water treatment system of claim 6, wherein the EC unit has a plurality of electrically charged plates, wherein the electrically charged plates are positioned to direct feed water flow evenly across the electrically charged plates.

18. A water treatment system comprising:
a mixing unit for receiving feed water to be treated and for combining an agent with the feed water to increase a pH level of the feed water;
a plurality of Electro-Coagulation (EC) unit coupled to the mixing unit;
a plurality of settling tank chambers coupled to the plurality of EC units, wherein each successive settling tank chamber removes smaller particles; and
a collection tank coupled to a last of the plurality of settling tank chambers.

19. The water treatment system of claim 18, further comprising a surge pump coupled to each of the plurality of settling tank chambers to remove particles collected in each of the settling tank chambers.

20. The water treatment system of claim 18, wherein each of the EC units has a plurality of electrically charged plates, wherein the electrically charged plates are positioned to direct feed water flow evenly across the electrically charged plates.
